(19) United States
(12) Patent Application Publication
(10) Pub. No.: US 2024/0199059 A1
(43) Pub. Date: Jun. 20, 2024

(54) OBJECT DETECTION DEVICE, OBJECT DETECTION METHOD, AND OBJECT DETECTION PROGRAM

(71) Applicant: DENSO CORPORATION, Kariya-city (JP)

(72) Inventors: Satoru NORO, Kariya-city (JP); Taketo HARADA, Kariya-city (JP)

(21) Appl. No.: 18/592,279

(22) Filed: Feb. 29, 2024

Related U.S. Application Data
(63) Continuation of application No. PCT/JP2022/029706, filed on Aug. 2, 2022.

(30) Foreign Application Priority Data
Sep. 1, 2021 (JP) 2021-142741

(51) Int. Cl. B60W 50/14; G01S 13/06; G01S 13/86; G01S 15/06; G06T 7/70

(52) U.S. Cl. CPC B60W 50/14; G01S 13/06; G01S 13/862; G01S 13/867; G01S 15/06; G06T 7/70

(57) ABSTRACT

An object detection device is provided with a noise state determination unit and a noise information processing unit. The noise state determination unit determines whether a reception state of exogenous noise in an object detecting sensor is a high noise state, while the object detection condition is valid. When it is determined that the noise notification processing unit is a high noise state, noise related notification corresponding to a generation of a restriction in the object detection function as a result of the high noise state is executed. The object detection device provides a difference in the noise related notification depending on a detection state of an object and a running state of an own vehicle.

### CROSS-REFERENCE TO RELATED APPLICATION

This application is the U.S. bypass application of International Application No. PCT/JP2022/029706 filed on Aug. 2, 2022 which designated the U.S. and claims priority to Japanese Patent Application No. 2021-142741 filed on Sep. 1, 2021, the contents of both of which are incorporated herein by reference.

### TECHNICAL FIELD

The present disclosure relates to an object detection device configured to detect objects present around an own vehicle. Moreover, the present disclosure also relates to an object detection method and an object detection program that detect objects present around the own vehicle.

### BACKGROUND

For example, JP 6089585 discloses a technique for improving noise resistance and preventing misdetection in an obstacle detection device that detects obstacles present around a vehicle using a ranging sensor such as an ultrasonic sensor. Specifically, the vehicle is equipped with two ultrasonic sensors, and each ultrasonic sensor has a function of detecting external noise. The obstacle detection device causes each ultrasonic sensor to detect exogenous noise before transmitting ultrasonic waves, and then causes one ultrasonic sensor to transmit ultrasonic waves. When even one of the two ultrasonic sensors detects exogenous noise, the obstacle detection device invalidates the detection information of all ultrasonic sensors including the ultrasonic sensor that does not detect the exogenous noise. When exogenous noise is not detected, the obstacle detection device determines that an obstacle is detected when both of the two ultrasonic sensors receive reflected waves exceeding the threshold, and otherwise determines that an obstacle is not detected.

According to the technique described in JP 6089585, when even one of the two ultrasonic sensors detects exogenous noise, the detection information of both ultrasonic sensors is invalidated, and therefore noise resistance can be improved compared to the case where only the detection information of the ultrasonic sensor that detected the exogenous noise is invalidated. Moreover, a warning is issued only when both ultrasonic sensors detect an obstacle, and therefore it is possible to prevent a warning from being issued caused by exogenous noise or objects on the road surface.

### SUMMARY

The object detection device is configured so as to detect objects present around an own vehicle.

According to one aspect of the present disclosure, the object detection device is provided with:
an object detection determination unit that determines, while the object detection condition is valid, whether the object is in a detection state where the object is detected, or the object is in a non-detection state where the object is not detected;
a noise state determination unit that determines, while the object detection condition is valid, whether the reception state of the exogenous noise in the object detection sensor is a high noise state; and
a noise notification processing unit that, when the noise state determination unit determines that the reception state of the exogenous noise is the high noise state, executes a noise related notification corresponding to a generation of a restriction in the object detection function as a result of the high noise state; wherein
the object detection device is configured such that the noise related notification is more readily executed in the detection state than in the non-detection state.

The object detection method is a method of detecting an object present around an own vehicle.

According to one aspect of the present disclosure, an object detection method includes:
determining, while the object detection condition is valid, whether the object is in a detection state where the object is detected, or the object is in a non-detection state where the object is not detected;
determining, while the object detection condition is valid, whether the reception state of the exogenous noise in the object detection sensor is a high noise state; and
when it is determined that the reception state of the exogenous noise is the high noise state, executing the noise related notification corresponding to a generation of a restriction in the object detection function as a result of the high noise state; wherein
the noise related notification is more readily executed in the detection state than in the non-detection state.

The object detection program is a program executed by an object detection device configured to detect objects present around an own vehicle.

According to one aspect of the present disclosure, in the object detection program, the process executed by the object detection device includes:
a process of determining, while the object detection condition is valid, whether the object is in a detection state where the object is detected, or the object is in a non-detection state where the object is not detected;
a process of determining, while the object detection condition is valid, whether the reception state of the exogenous noise in the object detection sensor is a high noise state; and
when it is determined that the reception state of the exogenous noise is the high noise state, executing the noise related notification corresponding to a generation of a restriction in the object detection function as a result of the high noise state; wherein
the noise related notification is more readily executed in the detection state than in the non-detection state.

### BRIEF DESCRIPTION OF THE DRAWINGS

The above features of the present disclosure will be made clearer by the following detailed description, given referring to the appended drawings. In the accompanying drawings:

FIG. 1 is a plan view showing a schematic configuration of a vehicle equipped with an object detection device according to an embodiment of the present disclosure;

FIG. 2 is a block diagram showing a schematic functional configuration in one embodiment of the object detection device shown in FIG. 1;

FIG. 3 are time charts showing an outline of a first operation example in the object detection device shown in FIG. 2;

FIG. 4 is a flowchart showing an outline of a second operation example in the object detection device shown in FIG. 2;

FIG. 5 is a flowchart showing an outline of a third operation example in the object detection device shown in FIG. 2; and

FIG. 6 is a table showing an outline of a fourth operation example in the object detection device shown in FIG. 2.

### DETAILED DESCRIPTION OF THE PREFERRED EMBODIMENTS

In the type of technique described in JP 6089585, when the object detection function is restricted by the exogenous noise, it is assumed that there will be a need to notify the user (that is, an occupant such as a driver) of that effect. In this respect, when the noise determination results are uniformly notified regardless of the circumstances, it may end up reducing the convenience of the user.

The present disclosure has been made in light of the circumstances and the like exemplified above. That is, the present disclosure provides, for example, a technique capable of satisfactorily notifying the user that the object detection function has been restricted by the exogenous noise while curbing reduction of convenience.

The object detection device is configured so as to detect objects present around an own vehicle.

According to one aspect of the present disclosure, the object detection device is provided with:
an object detection determination unit that determines, while the object detection condition is valid, whether the object is in a detection state where the object is detected, or the object is in a non-detection state where the object is not detected;
a noise state determination unit that determines, while the object detection condition is valid, whether the reception state of the exogenous noise in the object detection sensor is a high noise state; and
a noise notification processing unit that, when the noise state determination unit determines that the reception state of the exogenous noise is the high noise state, executes a noise related notification corresponding to a generation of a restriction in the object detection function as a result of the high noise state; wherein
the object detection device is configured such that the noise related notification is more readily executed in the detection state than in the non-detection state.

According to another aspect of the present disclosure, the object detection device is provided with:
a noise state determination unit that determines, while the object detection condition is valid, whether the reception state of the exogenous noise in the object detection sensor is a high noise state; and
a noise notification processing unit that, when the noise state determination unit determines that the reception state of the exogenous noise is the high noise state, executes a noise related notification corresponding to a generation of a restriction in the object detection function as a result of the high noise state; wherein
the object detection device is configured such that the ease of executing the noise related notification is determined depending on the running conditions of an own vehicle.

The object detection method is a method of detecting an object present around an own vehicle.

According to one aspect of the present disclosure, an object detection method includes:
determining, while the object detection condition is valid, whether the object is in a detection state where the object is detected, or the object is in a non-detection state where the object is not detected;
determining, while the object detection condition is valid, whether the reception state of the exogenous noise in the object detection sensor is a high noise state; and
when it is determined that the reception state of the exogenous noise is the high noise state, executing the noise related notification corresponding to a generation of a restriction in the object detection function as a result of the high noise state; wherein
the noise related notification is more readily executed in the detection state than in the non-detection state.

According to another aspect of the present disclosure, an object detection method includes:
determining, while the object detection condition is valid, whether the reception state of the exogenous noise in the object detection sensor is a high noise state;
when it is determined that the reception state of the exogenous noise is the high noise state, executing the noise related notification corresponding to a generation of a restriction in the object detection function as a result of the high noise state; and
determining the ease of executing the noise related notification depending on the running conditions of an own vehicle.

The object detection program is a program executed by an object detection device configured to detect objects present around an own vehicle.

According to one aspect of the present disclosure, in the object detection program, the process executed by the object detection device includes:
a process of determining, while the object detection condition is valid, whether the object is in a detection state where the object is detected, or the object is in a non-detection state where the object is not detected;
a process of determining, while the object detection condition is valid, whether the reception state of the exogenous noise in the object detection sensor is a high noise state; and
when it is determined that the reception state of the exogenous noise is the high noise state, executing the noise related notification corresponding to a generation of a restriction in the object detection function as a result of the high noise state; wherein
the noise related notification is more readily executed in the detection state than in the non-detection state.

According to another aspect of the present disclosure, in the object detection program, wherein
the process executed by the object detection device includes:
a process of determining, while the object detection condition is valid, whether the reception state of the exogenous noise in the object detection sensor is the high noise state;
when it is determined that the reception state of the exogenous noise is the high noise state, a process of executing the noise related notification corresponding to a generation of a restriction in the object detection function as a result of the high noise state; and
a process of determining the ease of executing the noise related notification depending on the running conditions of an own vehicle.

### Embodiments

Hereinafter, embodiments of the present disclosure will be described based on the drawings. Incidentally, if various modifications applicable to one embodiment are inserted in the middle of a series of explanations related to the embodiment, there is a risk that the understanding of the embodiment might be inhibited. As such, modifications will not be described in the middle of a series of explanations related to the embodiment, but will be collectively described after the series of such explanations.

### Overall Configuration of the Vehicle

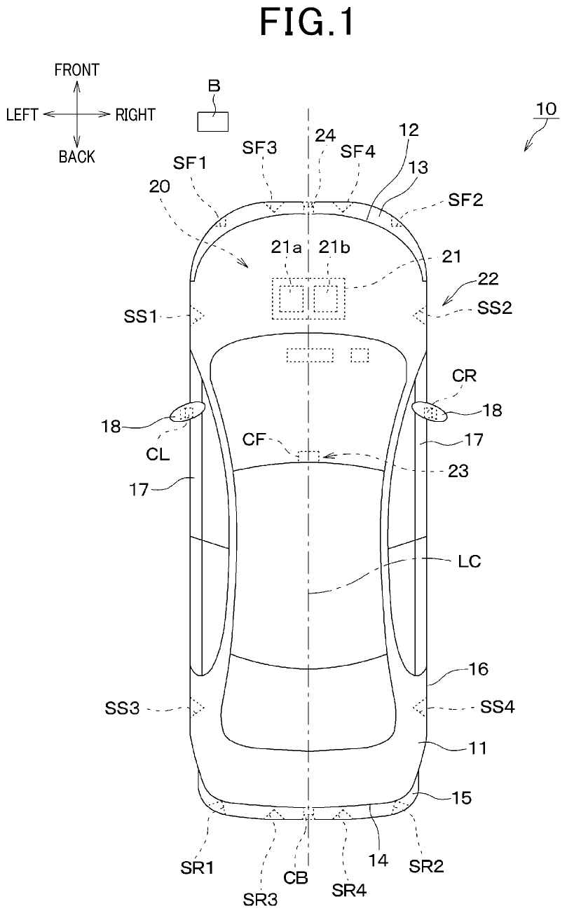

Referring to FIG. 1, a vehicle 10 is a so-called four-wheeled vehicle, and is provided with a substantially rectangular vehicle body 11 in a plan view. Hereinafter, an imaginary straight line passing through the center of the vehicle 10 in the vehicle width direction, and parallel to the vehicle length direction of the vehicle 10 will be referred to as a vehicle center axis LC. In FIG. 1, the vehicle width direction is either horizontal direction (that is, right or left) in the drawing. The vehicle length direction is a direction orthogonal to the vehicle width direction and orthogonal to the vehicle height direction. The vehicle height direction is a direction that defines the vehicle height of the vehicle 10, and is a direction parallel to the direction of the action of gravity when the vehicle 10 is stably mounted on a horizontal plane in a drivable state.

For the sake of convenience of explanation, “front”, “rear”, “left”, and “right” of the vehicle 10 are defined as indicated by arrows in FIG. 1. That is, the vehicle length direction is synonymous with the front and rear directions. Moreover, the vehicle width direction is synonymous with the left and right directions. Incidentally, there may be cases where the vehicle height direction is not parallel to the direction of the action of gravity depending on the mounting conditions or running conditions of the vehicle 10. However, in many cases, the vehicle height direction is the direction along the action of gravity.

A front bumper 13 is attached to a front part 12 which is an end part on the front side of the vehicle body 11. A rear bumper 15 is attached to a rear part 14 which is an end part on the rear side of the vehicle body 11. A door panel 17 is attached to a side part 16 of the vehicle body 11. In the specific example shown in FIG. 1, a total of four door panels 17, two on the right and the left sides, respectively, are provided. A door mirror 18 is mounted to each of the pair of left and right door panels 17 on the front side.

### In-vehicle System

The vehicle 10 is loaded with an in-vehicle system 20. The in-vehicle system 20 is configured to execute driving control or driving support control in the vehicle 10. Hereinafter, the vehicle 10 loaded with the in-vehicle system 20 may be abbreviated as “an own vehicle”.

The in-vehicle system 20 is provided with an object detection ECU 21. ECU stands for Electronic Control Unit. The object detection ECU 21 is arranged inside the vehicle body 11. The object detection ECU 21 is a so-called in-vehicle microcomputer, and it is provided with a processor 21a and a memory 21b. The processor 21a is composed of a CPU and an MPU. The memory 21b is provided with at least an ROM or non-volatile rewritable memory among various storage media such as an ROM, RAM, non-volatile rewritable memory and the like. The non-volatile rewritable memory is a storage device, such as a flash ROM, which can rewrite information while the power is turned on, but retains the information in a non-rewritable state while the power is turned off. ROM and non-volatile rewritable memory correspond to computer-readable non-transitory tangible storage media. The memory 21b stores in advance programs corresponding to operation outlines or flow charts, which will be described later, and various data (for example, initial values, lookup tables, maps, etc.) used when executing the programs. The object detection ECU 21 constituting the object detection device according to the present disclosure is configured so that the processor 21a reads and executes the programs stored in the memory 21b to detect an object B present around the own vehicle.

In the present embodiment, the object detection ECU 21 is configured to detect the object B using at least a sonar sensor 22. The sonar sensor 22 is a ranging sensor that detects the distance to the object B and is mounted to the vehicle body 11. In the present embodiment, the sonar sensor 22 is a so-called ultrasonic sensor, and is configured to transmit search waves, which are ultrasonic waves, toward the outside of the vehicle and to receive received waves including ultrasonic waves. That is, the sonar sensor 22 is provided to generate and output distance measurement information, which is the result of detecting the distance to the distance measurement point on the object B, by receiving the received waves including the reflected waves of the search waves from the object B. A “ranging point” is a point on the surface of the object B that is presumed to have reflected the search wave transmitted from the sonar sensor 22.

### Object Detecting Sensor

The in-vehicle system 20 is provided with at least one sonar sensor 22. Specifically, in the present embodiment, a plurality of sonar sensors 22 are provided. The plurality of sonar sensors 22 are arranged from the vehicle center axis LC toward one side in the vehicle width direction. Moreover, at least some of the plurality of sonar sensors 22 are arranged so as to transmit the search waves along the direction intersecting the vehicle center axis LC.

Specifically, a first front sonar SF1, a second front sonar SF2, a third front sonar SF3, and a fourth front sonar SF4 as sonar sensors 22 are mounted to the front bumper 13. Similarly, a first rear sonar SR1, a second rear sonar SR2, a third rear sonar SR3, and a fourth rear sonar SR4 as sonar sensors 22 are mounted to the rear bumper 15. Moreover, a first side sonar SS1, a second side sonar SS2, a third side sonar SS3, and a fourth side sonar SS4 as sonar sensors 22 are mounted to the side part 16 of the vehicle body 11.

Hereinafter, a singular expression of a “sonar sensor 22” or an expression of “a plurality of sonar sensors 22” may be used when a specific sonar sensor of a first front sonar SF1, a second front sonar SF2, a third front sonar SF3, a fourth front sonar SF4, a first rear sonar SR1, a second rear sonar SR2, a third rear sonar SR3, a fourth rear sonar SR4, a first side sonar SS1, a second side sonar SS2, a third side sonar SS3, or a fourth side sonar SS4 is not used.

One sonar sensor 22 is referred to as a “first sonar sensor” and another sonar sensor 22 is referred to as a “second sonar sensor”, and “direct waves” and “indirect waves” are defined as follows. Received waves that are received by the first sonar sensor, and the received waves caused by reflected waves of the search waves transmitted from the first sonar sensor by the object B are referred to as “direct waves”. That is, direct waves are the received waves when the sonar sensor 22 that transmitted the search waves, and the sonar sensor 22 that detected the reflected waves of the search waves from the object B as the received waves are the same. On the other hand, received waves that are received by the second sonar sensor and the received waves caused by reflected waves from the object B of the search waves transmitted from the first sonar sensor are called “indirect waves”. That is, indirect waves are the received waves when the sonar sensor 22 that transmitted the search waves are different from the sonar sensor 22 that detected the reflected waves of the search waves from the object B as the received waves.

The first front sonar SF1 is mounted at a position close to the left end of the front bumper 13 so as to transmit the search waves in the forward left direction of the own vehicle. The second front sonar SF2 is mounted at a position close to the right end of the front bumper 13 so as to transmit the search waves in the right front direction of the own vehicle. The first front sonar SF1 and the second front sonar SF2 are arranged symmetrically with respect to the vehicle center axis LC.

The third front sonar SF3 and the fourth front sonar SF4 are arranged in the vehicle width direction at positions close to the center of the front bumper 13. The third front sonar SF3 is arranged between the first front sonar SF1 and the vehicle center axis LC in the vehicle width direction so as to transmit the search waves in a substantially forward direction of the own vehicle. The fourth front sonar SF4 is arranged between the second front sonar SF2 and the vehicle center axis LC in the vehicle width direction so as to transmit the search waves in a substantially forward direction of the own vehicle. The third front sonar SF3 and the fourth front sonar SF4 are arranged symmetrically with respect to the vehicle center axis LC.

As described above, the first front sonar SF1 and the third front sonar SF3 mounted on the left side of the vehicle body 11 are arranged at different positions from each other in a plan view. Moreover, the first front sonar SF1 and the third front sonar SF3, which are adjacent to each other in the vehicle width direction, are in a positional relationship such that the reflected waves reflected by object B of the search waves which either one transmitted reciprocally can be received by the other as received waves.

That is, the first front sonar SF1 is arranged so as to be able to receive both the direct waves corresponding to the search waves transmitted by itself and the indirect waves corresponding to the search waves transmitted by the third front sonar SF3. Similarly, the third front sonar SF3 is arranged so as to be able to receive both the direct waves corresponding to the search waves transmitted by itself and the indirect waves corresponding to the search waves transmitted by the first front sonar SF1.

Similarly, the third front sonar SF3 and the fourth front sonar SF4 mounted close to the center of the vehicle body 11 in the vehicle width direction are arranged at different positions from each other in a plan view. Moreover, the third front sonar SF3 and the fourth front sonar SF4, which are adjacent to each other in the vehicle width direction, are in a positional relationship such that the reflected waves reflected by object B of the search waves which either one transmitted reciprocally can be received by the other as received waves.

Similarly, the second front sonar SF2 and the fourth front sonar SF4 mounted on the right side of the vehicle body 11 are arranged at different positions from each other in a plan view. Moreover, the second front sonar SF2 and the fourth front sonar SF4, which are adjacent to each other in the vehicle width direction, are in a positional relationship such that the reflected waves reflected by object B of the search waves which either one transmitted reciprocally can be received by the other as received waves.

The first rear sonar SR1 is mounted at a position close to the left end of the rear bumper 15 so as to transmit the search waves to the backward left of the own vehicle. The second rear sonar SR2 is mounted at a position close to the right end of the rear bumper 15 so as to transmit the search waves to the backward right of the vehicle. The first rear sonar SR1 and the second rear sonar SR2 are arranged symmetrically with respect to the vehicle center axis LC.

The third rear sonar SR3 and the fourth rear sonar SR4 are arranged in the vehicle width direction at positions close to the center of the rear bumper 15. The third rear sonar SR3 is arranged between the first rear sonar SR1 and the vehicle center axis LC in the vehicle width direction so as to transmit the search waves in a substantially backward direction of the own vehicle. The fourth rear sonar SR4 is arranged between the second rear sonar SR2 and the vehicle center axis LC in the vehicle width direction so as to transmit the search waves in a substantially backward direction of the own vehicle. The third rear sonar SR3 and the fourth rear sonar SR4 are arranged symmetrically with respect to the vehicle center axis LC.

As described above, the first rear sonar SR1 and the third rear sonar SR3 mounted on the left side of the vehicle body 11 are arranged at different positions from each other in a plan view. Moreover, the first rear sonar SR1 and the third rear sonar SR3, which are adjacent to each other in the vehicle width direction, are provided in a positional relationship such that the reflected waves reflected by object B of the search waves which either one transmitted reciprocally can be received by the other as received waves.

That is, the first rear sonar SR1 is arranged so as to be able to receive both the direct waves corresponding to the search waves transmitted by itself and the indirect waves corresponding to the search waves transmitted by the third rear sonar SR3. Similarly, the third rear sonar SR3 is arranged so as to be able to receive both the direct waves corresponding to the search waves transmitted by itself and the indirect waves corresponding to the search waves transmitted by the first rear sonar SR1.

Similarly, the third rear sonar SR3 and the fourth rear sonar SR4, which are mounted close to the center of the vehicle body 11 in the vehicle width direction, are arranged at different positions from each other in a plan view. Moreover, the third rear sonar SR3 and the fourth rear sonar SR4, which are adjacent to each other in the vehicle width direction, are provided in a positional relationship such that the reflected waves reflected by object B of the search waves which either one transmitted reciprocally can be received by the other as received waves.

Similarly, the second rear sonar SR2 and the fourth rear sonar SR4 mounted on the right side of the vehicle body 11 are arranged at different positions in a plan view. Further, the second rear sonar SR2 and the fourth rear sonar SR4, which are adjacent to each other in the vehicle width direction, are provided in a positional relationship such that the reflected waves of the survey waves transmitted by one of them and reflected by the object B can be received by the other as received waves. Moreover, the second rear sonar SR2 and the fourth rear sonar SR4, which are adjacent to each other in the vehicle width direction, are provided in a positional relationship such that the reflected waves reflected by object B of the search waves which either one transmitted reciprocally can be received by the other as received waves.

The first side sonar SS1, the second side sonar SS2, the third side sonar SS3, and the fourth side sonar SS4 are provided so as to transmit the search waves from the vehicle side face, which is the outer surface of the side part 16, to the side face of the own vehicle. The first side sonar SS1, the second side sonar SS2, the third side sonar SS3, and the fourth side sonar SS4 are each provided so as to be able to receive only the direct waves.

The first side sonar SS1 is arranged between the door mirror 18 and the first front sonar SF1 on the left side in the front and back direction so as to transmit the search waves to the left of the own vehicle. The second side sonar SS2 is arranged between the door mirror 18 and the second front sonar SF2 on the right side in the front and back direction so as to transmit the search waves to the right of the own vehicle. The first side sonar SS1 and the second side sonar SS2 are provided symmetrically with respect to the vehicle center axis LC.

The third side sonar SS3 is arranged between the door panel 17 and the first rear sonar SR1 on the left rear side in the front and back direction so as to transmit the search waves to the left of the own vehicle. The fourth side sonar SS4 is arranged between the door panel 17 and the second rear sonar SR2 on the right rear side in the front and back direction so as to transmit the search waves to the right of the own vehicle. The third side sonar SS3 and the fourth side sonar SS4 are provided symmetrically with respect to the vehicle center axis LC.

Each of the plurality of the sonar sensors 22 is connected to the object detection ECU 21 via an in-vehicle communication line so that information communication is possible. Each of the plurality of sonar sensors 22 transmits the search waves under the control of the object detection ECU 21, and generates signals corresponding to the reception result of the received waves and outputs the signals so that it can be received by the object detection ECU 21. Information included in the signals corresponding to the reception result of the received waves is hereinafter referred to as “ranging information”. The ranging information includes information relating to reception intensity of the received waves and distance information. “Distance information” is information relating to the distance between each of the plurality of sonar sensors 22 and the object B. Specifically, for example, the distance information includes information relating to the time difference between the reception of the search waves and the reception of the received waves.

The in-vehicle system 20 is provided with a camera 23 and a radar sensor 24 in addition to the sonar sensor 22 as an object detection sensor for detecting object B around the own vehicle. The camera 23 is mounted on the own vehicle so as to move along with the movement of the own vehicle while capturing images around the own vehicle. The camera 23 is configured so as to generate image information corresponding to captured images of the surroundings of the own vehicle. In the present embodiment, the camera 23 is a digital camera device, and is provided with an image sensor such as a CCD, CMOS and the like. CCD stands for a Charge Coupled Device. CMOS stands for a Complementary MOS.

In the present embodiment, a plurality of cameras 23, that is, a front camera CF, a rear camera CB, a left camera CL, and a right camera CR are mounted on the vehicle 10. Hereinafter, a singular expression of a “camera 23” or “a plurality of cameras 23” may be used when a specific camera of a front camera CF, a rear camera CB, a left camera CL, or a right camera CR is not used.

The front camera CF is provided to acquire image information corresponding to images in the front direction of the own vehicle. The rear camera CB is mounted to the rear part 14 of the vehicle body 11 so as to acquire image information corresponding to images in the back direction of the own vehicle. The left camera CL is mounted to the door mirror 18 on the left side so as to acquire image information corresponding to images in the left direction of the own vehicle. The right camera CR is mounted to the door mirror 18 on the right side so as to acquire image information corresponding images in the right direction of the own vehicle. Each of the plurality of cameras 23 is connected to the object detection ECU 21 via an in-vehicle communication line so that information communication is possible. That is, each of the plurality of cameras 23 outputs acquired or generated image information so that it can be received by the object detection ECU 21.

A radar sensor 24 is a laser radar sensor or millimeter wave radar sensor that transmits and receives radar waves, and is mounted to the front part 12 of the vehicle body 11. The radar sensor 24 is connected to the object detection ECU 21 via an in-vehicle communication line so that information communication is possible. The radar sensor 24 is configured to generate signals corresponding to the position and relative velocity of the reflection point, and to output the signals so that it can be received by the object detection ECU 21. A “reflection point” is a point on the surface of the object B that is presumed to have reflected the radar waves. A “relative velocity” is the relative velocity of the reflection point, that is, the object B that reflected the radar waves, with respect to the own vehicle.

### Object Detection Device

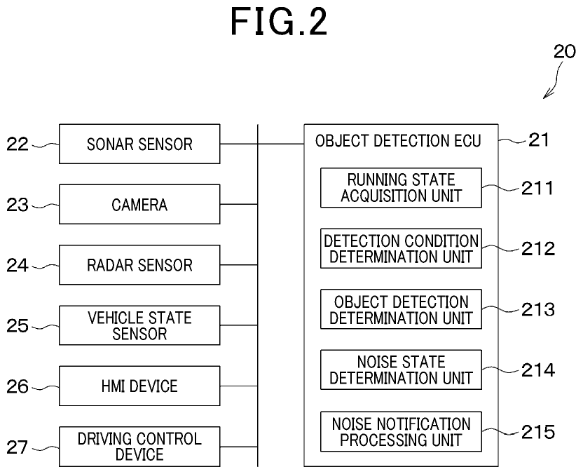

Referring to FIG. 2, the in-vehicle system 20 is further provided with a vehicle state sensor 25, an HMI device 26, and an operation control device 27. HMI stands for Human Machine Interface. Incidentally, to simplify the illustration, the plurality of sonar sensors 22 shown in FIG. 1, that is, the first front sonar SF1 to the fourth side sonar SS4 are collectively shown as the sonar sensors 22 in FIG. 2. Similarly, the plurality of cameras 23 shown in FIG. 1, that is, the front camera CF, etc., are collectively shown as cameras 23 in FIG. 2.

A vehicle state sensor 25 is connected to the object detection ECU 21 via an in-vehicle communication line so that information communication is possible. The vehicle state sensor 25 is provided so as to generate information or signals corresponding to various quantities relating to the driving state of the own vehicle, and output the information or signals to the object detection ECU 21. The “various quantities relating to driving state” include various quantities relating to driving operation state such as accelerator operation amount, braking operation amount, shift positions, steering angles, and the like. Moreover, the “various quantities relating to driving state” include physical quantities relating to the behavior of the own vehicle, such as vehicle speed, angular velocity, front and back directional acceleration, left and right directional acceleration and the like. That is, the vehicle state sensor 25 is a generic term to simplify drawings and explanations including well-known sensors necessary to control vehicle operation, such as a shift position sensor, vehicle speed sensor, accelerator opening sensor, steering angle sensor, angular velocity sensor, acceleration sensor, yaw rate sensor and the like.

The HMI device 26 is connected to the object detection ECU 21 via an in-vehicle communication line so that information communication is possible. The HMI device 26 is configured to provide various types of information to occupants such as the driver. Specifically, the HMI device 26 is provided with at least one of a display device such as a gauge or a display device, an audio output device such as a speaker, and a haptic device that imparts stimulation such as vibration to occupants such as a driver.

The operation control device 27 is connected to the object detection ECU 21 via an in-vehicle communication line so that information communication is possible. The operation control device 27 is configured to execute motion control of the own vehicle in the longitudinal and lateral directions, that is, the operation control device 27 is a generic term to simplify drawings and explanations of the configuration for executing motion control in the longitudinal direction and the lateral direction of the own vehicle such as a drive control device, a braking control device, a steering control device and the like.

As such, the object detection ECU 21 is configured to execute the object detection operation based on the detection results of the object detection sensors such as the sonar sensor 22 and the running state of the own vehicle acquired by the vehicle state sensor 25. Further, the in-vehicle system 20 is configured to execute various vehicle control operations (for example, collision avoidance operation, parking assistance operation, etc.) based on the detection result of object B, that is, an obstacle around the own vehicle. Moreover, the in-vehicle system 20 is configured to execute notification operations and warning operations regarding obstacle detection results and the accompanying vehicle control operations by the HMI device 26.

FIG. 2 shows an outline of the functional configuration of the object detection ECU 21 implemented on a microcomputer. The object detection ECU 21 is provided as functional configurations with a running state acquisition unit 211, a detection condition determination unit 212, an object detection determination unit 213, a noise state determination unit 214, and a noise notification processing unit 215. Hereinafter, details of the functional configuration of the object detection ECU 21 in the present embodiment will be described.

The running state acquisition unit 211 acquires the running state of the own vehicle. Specifically, the running state acquisition unit 211 determines the driving state of the own vehicle based on information or signals corresponding to various quantities relating to driving state of the own vehicle acquired from the vehicle state sensor 25. The “running state” here means not only the driving operation state or motion state of the own vehicle such as shift positions, vehicle speed, acceleration/deceleration amount, steering direction, steering amount, but also the driving scene of the own vehicle determined from these data. The “driving scene” includes, for example, reversing, driving at low speed, starting, turning right, changing lanes, sudden braking and the like.

The detection condition determination unit 212 determines whether an object detection condition, which is a condition for executing an object detection operation, is met based on the results obtained by the running state acquisition unit 211. In the present embodiment, the object detection conditions include the shift position being a driving position including reverse, the vehicle speed being within a predetermined range and the like.

The object detection determination unit 213 determines the presence or absence of the object B within a predetermined region around the own vehicle based on the detection results of the object detection sensors such as the sonar sensor 22 while the object detection conditions are valid. That is, the object detection determination unit 213 determines whether it is in the detection state or the non-detection state. A “detection state” is a state in which the object B is detected. A “non-detection state” is a state in which the object B is not detected. Moreover, the object detection determination unit 213 calculates the relative position of such object B with respect to the own vehicle when the object B exists within a predetermined region around the own vehicle.

The noise state determination unit 214 determines whether the reception state of the exogenous noise of the sonar sensor 22, which is the object detection sensor, is a high noise state while the object detection condition is valid. “Exogenous noise” is a contrary concept to “endogenous noise”. “Endogenous noise” is noise generated inside the sensor, that is, it is the noise caused by the operation of the sensor itself that detects a noise, such as thermal noise. In contrast, “exogenous noise” is noise different from the endogenous noise, and may also be referred to as “external noise” or “environmental noise”. That is, “exogenous noise” is noise caused by reception of ultrasonic waves other than the reflected waves reflected by the object B of the search waves transmitted from the own vehicle. Specifically, exogenous noise includes, for example, search waves from other vehicles, ultrasonic waves generated by air brakes of trucks and buses, ultrasonic waves emitted from ultrasonic sensors for vehicle detection provided at vehicle-sensitive intersections and the like. Moreover, exogenous noise also includes the effects derived from objects that temporarily contact the surface of the sonar sensor 22, such as running water flowing over the sonar sensor 22. A “high noise state” is a state in which the reception state of the exogenous noise exceeds predetermined determination criteria.

More specifically, the noise state determination unit 214 acquires, that is, calculates characteristic values corresponding to the reception state of the exogenous noise. The “characteristic values” are values corresponding to the existence state of the exogenous noise in the received waves, which are ultrasonic waves received by the sonar sensor 22. Specifically, the “characteristic values” include, for example, a reception frequency of the exogenous noise. The “reception frequency” is a frequency of receiving the exogenous noise during the noise monitor period provided immediately prior to the transmission timing of the search waves. More specifically, the “reception frequency” is the number of counts obtained by the following method: when the exogenous noise is received even once during the noise monitor period, it is counted as 1 count. Alternatively, the “characteristic values” may include, for example, the duration or the number of continuations that the reception frequency of the exogenous noise exceeds a predetermined frequency threshold. The “number of continuations” is the number of times that the determination that the reception frequency of the exogenous noise exceeds a predetermined frequency threshold continued. Further, the noise state determination unit 214 determines whether a high noise state is established in which the reception state of the exogenous noise exceeds predetermined determination criteria. Specifically, the noise state determination unit 214 determines that the high noise state is established when the characteristic value exceeds a determination threshold value corresponding to the determination criteria.

The noise notification processing unit 215 executes the noise related notification using the HMI device 26 when the noise state determination unit 214 determines that the high noise state is reached. The “noise related notification” is a notification for providing occupants such as a driver with information corresponding to the fact that the object detection function is restricted by a high noise state. That is, when the detection condition determination unit 212 determines that the object detection conditions are established, and the noise state determination unit 214 determines that a high noise state is reached, the noise notification processing unit 215 executes the noise related notification. Moreover, the noise notification processing unit 215 changes the execution modes (that is, frequency and content) of the noise related notification depending on the reception state of the exogenous noise (that is, for example, duration and the number of times).

In the present embodiment, the object detection ECU 21 is configured to provide a difference in determination of a high noise state and noise related notification depending on either one of the detection states of the object B and the running state of the own vehicle. Specifically, the object detection ECU 21 is configured such that noise related notification is more readily performed in the detected state than in the non-detected state. Alternatively, the object detection ECU 21 is configured to determine the ease with which the noise related notification is executed depending on the running state of the own vehicle. Specifically, the noise notification processing unit 215 changes the execution modes of the noise related notification (that is, for example, presence or absence of execution, frequency, content, etc.) depending on the possibility of collision between the detected object B and the own vehicle.

### Operation Outline

Hereinafter, the outline of the operation of the in-vehicle system 20 according to the present embodiment, that is, the object detection ECU 21, and the outline of the object detection method and object detection program executed by the object detection ECU 21, along with the effects produced thereby, will be described with reference to each drawing. Hereinafter, the object detection ECU 21 according to the present embodiment and the object detection method and object detection program executed thereby are collectively referred to as “the present embodiment”.

The vehicle state sensor 25 acquires or generates information or signals corresponding to various quantities relating to driving state of the own vehicle, and outputs the information or signals to the object detection ECU 21. The object detection ECU 21 determines whether the object detection conditions are established based on the information or signals received from the vehicle state sensor 25. When the object detection conditions are established, the object detection ECU 21 causes each of the plurality of sonar sensors 22 to execute the transmission/reception operations at predetermined time intervals. That is, the object detection ECU 21 controls the transmission/reception timing of each of the plurality of sonar sensors 22. Each of the plurality of sonar sensors 22 measures the distance to a ranging point on an object B present around the own vehicle by receiving received waves including reflected waves of the search waves. Moreover, each of the plurality of sonar sensors 22 outputs acquired or generated ranging information so that the object detection ECU 21 can receive it.

Specifically, when the object detection ECU 21 controls the transmission/reception operations of the first front sonar SF1 to the fourth front sonar SF4, the object detection ECU 21 sets a specific sensor among the sensors as a “transmission/reception sensor” and sets the remaining sensors as “reception sensors”. The “transmission/reception sensor” monitors the exogenous noise during the noise monitor period immediately before the transmission timing, then transmits the search waves for a predetermined transmission time from the transmission timing, waits for a predetermined reverberation waiting time after the transmission is completed, and execute the reception operation for receiving the direct waves after the reverberation subsides. That is, the transmission/reception operation in the transmission/reception sensor includes a noise monitor operation, transmission operation, and reception operation. The reception sensor monitors the exogenous noise during the noise monitor period immediately preceding the transmission timing of the transmission/reception sensor, and then executes a reception operation for receiving indirect waves from this transmission timing. That is, the transmission/reception operation in the reception sensor includes the noise monitor operation and the reception operation. The transmission/reception operation in the transmission/reception sensor and the transmission/reception operation in the reception sensor are synchronized. That is, the noise monitor period in the transmission/reception sensor and the noise monitor period in the reception sensor substantially coincide with each other. Moreover, the reception operation terminating timing in the transmission/reception sensor and the reception operation terminating timing in the reception sensor substantially coincide with each other. The object detection ECU 21 switches the transmission/reception sensors at predetermined time intervals. Specifically, for example, the object detection ECU 21 switches the transmission/reception sensors in the order of the third front sonar SF3, fourth front sonar SF4, first front sonar SF1 plus second front sonar SF2, third front sonar SF3 and the like. The same holds true in the case of controlling the transmission/reception operations of the first rear sonar SR1 to the fourth rear sonar SR4. The transmission timings of the first rear sonar SR1 to the fourth rear sonar SR4 are synchronized with the transmission timings of the first front sonar SF1 to the fourth front sonar SF4. In the first side sonar SS1 to the fourth side sonar SS4, reception of direct waves alone is expected, and therefore transmission/reception operations are synchronized with the transmission/reception sensors in the first front sonar SF1 to the fourth front sonar SF4.

The object detection ECU 21 receives ranging information from each of the plurality of sonar sensors 22. Moreover, the object detection ECU 21 receives image information from each of the plurality of cameras 23. Moreover, the object detection ECU 21 receives signals corresponding to the position and relative velocity of the reflection point on the object B from the radar sensor 24. Further, the object detection ECU 21 detects the object B based on signals and information received from each of the plurality of sonar sensors 22, each of the plurality of cameras 23, radar sensor 24, and vehicle state sensor 25.

For example, the object detection determination unit 213 recognizes the image of the three-dimensional shape of the object B and its relative position to the own vehicle based on the image information acquired by the camera 23, using a well-known method such as a mobile stereo. Moreover, the object detection determination unit 213 calculates the relative position of the object B with respect to the own vehicle by triangulation using a plurality of sonar sensors 22. Further, the object detection determination unit 213 recognizes the object B based on the results of image recognition of the object B, the detection results by the sonar sensor 22, and the ranging results by the radar sensor 24. That is, in the present embodiment, the object detection determination unit 213 detects the object B as an obstacle using a so-called “sensor fusion” technique that fuses the image recognition results with the ranging results.

By the way, in the surroundings of the own vehicle, ultrasonic waves that can be exogenous noise to the sonar sensor 22 are overflowing. In such a situation where exogenous noise from the surrounding environment is frequently received, the detection state of the object B can be difficult to verify by the reception of the exogenous noise, thereby restricting the object detection function.

In this regard, there is a need to notify the user, who is an occupant such as a driver, of the restriction of the object detection function caused by the exogenous noise. However, if the noise determination results are notified uniformly regardless of the situation, the user's convenience may end up being deteriorated. Specifically, for example, in an operating situation in which an assistance to the sonar sensor 22 is not required, frequent noise notification may annoy the user. On the other hand, for example, in an operating situation in which an assistance to the sonar sensor 22 is required, a user may misidentify that the sonar sensor 22 and the object detection function using the sonar sensor 22 are operating normally unless it is accurately notified that the reliability of the sensor is deteriorated by the exogenous noise.

Here, for example, in a case in which object B is not detected, a case in which the driver is driving while following a vehicle or passing an oncoming vehicle, or a case in which the driver can well visually recognize the surroundings of the own vehicle, there is no risk of colliding with the object B. In such a case, it is preferable not to perform excessive determination of high noise state or noise related notification. On the other hand, there may be cases in which there is a risk that the own vehicle may collide with an object B in the surroundings, and a user such as a driver needs assistance from the sonar sensor 22 and an object detection function using the sonar sensor 22. Such a case includes, for example, a case in which an object B actually exists or is very likely to exist in the driver's blind spot, or a case in which the driver is closing in to an object B. In such a case, it is preferable to accurately inform the user that the object detection function is restricted due to the high noise state.

As such, in the present embodiment, a difference is provided in the determination of the high noise state and the noise related notification depending on the detection state of the object B and the running state of the own vehicle. As a result, it is possible to favorably notify the user that the object detection function has been restricted by the exogenous noise while suppressing deterioration in convenience.

Specifically, in the present embodiment, determination of high noise state and noise related notification are more easily performed in the detection state than in the non-detection state. More specifically, the present embodiment uses, for example, a lower determination threshold in the detected state than in the non-detected state. Alternatively, in the present embodiment, for example, continuation of a predetermined degree (that is, a predetermined period of time or a predetermined number of times) of a reception state of the exogenous noise is the condition for determining the high noise state in the non-detection state, unlike the detection state. Alternatively, the present embodiment determines the ease of executing the noise related notification depending on the running state of the own vehicle.

### Operation Example 1

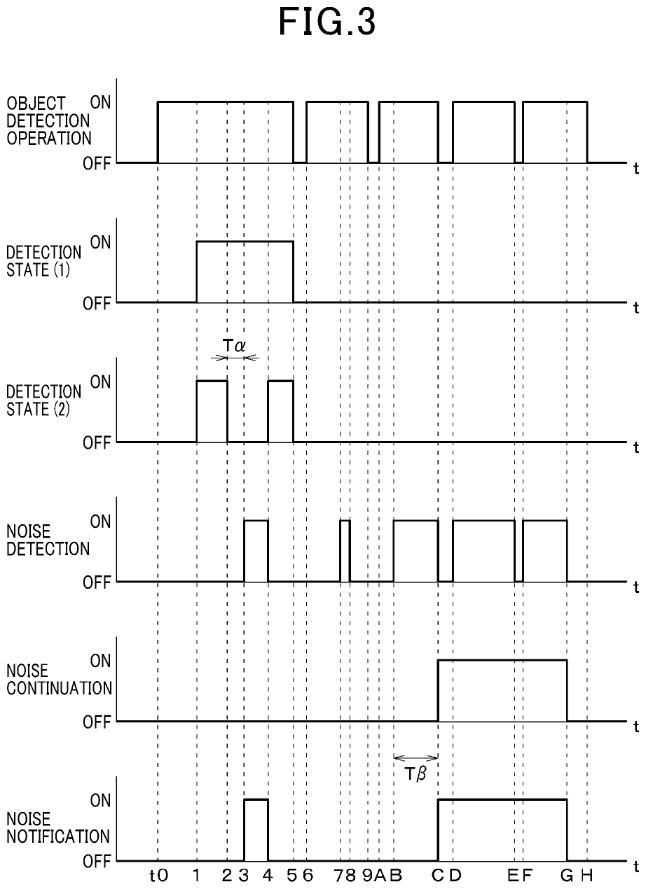

Hereinafter, a specific operation example according to the present embodiment will be described with reference to FIGS. 1 to 3. FIG. 3 show time charts corresponding to this operation example. In FIG. 3, the “object detection operation” is “ON” when the object detection condition is met and the object detection ECU 21 is executing the object detection operation, and is “OFF” otherwise. “Detection state (1)” indicates a “temporary” object detection determination in which it is estimated that the reflected wave of the search waves from an object B is received when the intensity of the received waves at the sonar sensor 22 exceeds the threshold. “Detection state (2)” indicates a state in which an object B corresponding to an obstacle is definitely detected within a predetermined region around the own vehicle. “Noise detection” indicates the detection state of the exogenous noise in the sonar sensor 22. “Noise continuation” indicates a state in which the noise detection state continues exceeding a predetermined determination threshold time. “Noise notification” indicates the execution timing of the noise related notification using the HMI device 26. Moreover, on the horizontal axis t indicating elapsed time, “1” to “H” show time other than time t0, where “t” is abbreviated from each of time t1 to tH for convenience of illustration.

The object detection operation starts at time t0, and when the received wave intensity exceeds the threshold at time t1, detection state (1) rises to ON. At this time, exogenous noise is not detected, and detection state (2) indicating a definite detection state also rises to ON at time t1. This state continues until time t2.

For some reason, only detection state (2) of detection state (1) and detection state (2) may fall to OFF. The reason for this may be, for example, failure in triangulation due to non-reception of either the direct waves or the indirect waves, in addition to reception of exogenous noise. However, it is expected that occurrence of such a situation lasts for a short period of time. As such, as shown in FIG. 3, a case is considered where exogenous noise is detected at time t3 after only detection state (2) of detection state (1) and detection state (2) fell to OFF at time t2. In this case, when the elapsed time Tα between time t2 and time t3 is short (that is, Tα<predetermined waiting time), the exogenous noise is assumed to be generated during a detection state of object B, and noise related notification starts from time t3. Incidentally, as for the reason that the object detection result became indefinite at time t2, it is possible that it was the reception of the exogenous noise that resulted in detection determination at time t3. That is, after the object detection result became indefinite due to the actual reception of the exogenous noise after time t2, and after a short time Tα has elapsed, it is possible that the reception determination of the exogenous noise is established.

When the noise detection shows OFF at time t4, the noise related notification ends. At this time, detection state (2) rises to ON. As such, it is found that the reason that the object detection result became indefinite at times t2 to t4 was the reception of the exogenous noise. When the object detection conditions are unmet at time t5, the object detection operation temporarily terminates. Incidentally, in this specific example, it is assumed that after time t5, object B does not exist within a predetermined region around the own vehicle, and both detection state (1) and detection state (2) show OFF.

At time t6, the object detection conditions are met again and the object detection operation starts, and at time t7 during the object detection operation, the exogenous noise is detected. At this time, object B is not detected. Therefore, at time t7, noise related notification corresponding to the detected exogenous noise is not executed. After that, at time t8, a relatively short time after time t7, the exogenous noise is undetected. As such, in the non-detection state, the noise related notification is not executed simply by detecting the exogenous noise, and continuation of the reception state of the exogenous noise in a predetermined degree is the determination condition for the high noise state or the execution condition for the noise related notification. After that, when the object detection conditions are unmet at time t9, the object detection operation is once terminated.

At time tA, the object detection conditions are met again and the object detection operation starts, and immediately after that at time tB, even if the exogenous noise is detected, noise related notification is not executed in the non-detection state by the same token as described above. After that, the object detection operation is interrupted for short periods of time tC to tD and time tE to tF. However, when the interruption time is less than the predetermined interruption threshold time, the counts of the reception state of the exogenous noise (that is, the elapsed time or the number of consecutive reception determinations) before and after the interruption are added up. Therefore, when the reception environment of the exogenous noise continues between time tB and tG, after time tC when the determination threshold time Tβ is elapsed, the noise continuation state rises to ON, and the noise related notification starts to be executed. The noise related notification is also executed between a short interruption time tE and tF, and terminates at time tG when the exogenous noise is no longer detected. fter that, when the object detection conditions are unmet at time tH, the object detection operation is once terminated.

As such, in this operation example, the noise related notification is more readily executed in a state in which object B, which may be an obstacle that may collide with the own vehicle, is detected than in a state in which the object B is not detected. Moreover, in this operation example, the noise notification processing unit 215 changes the execution modes of the noise related notification depending on the reception state of the exogenous noise. Therefore, according to this operation example, it is possible to favorably notify the user that the object detection function has been restricted due to the exogenous noise while suppressing deterioration in convenience.

### Operation Example 2

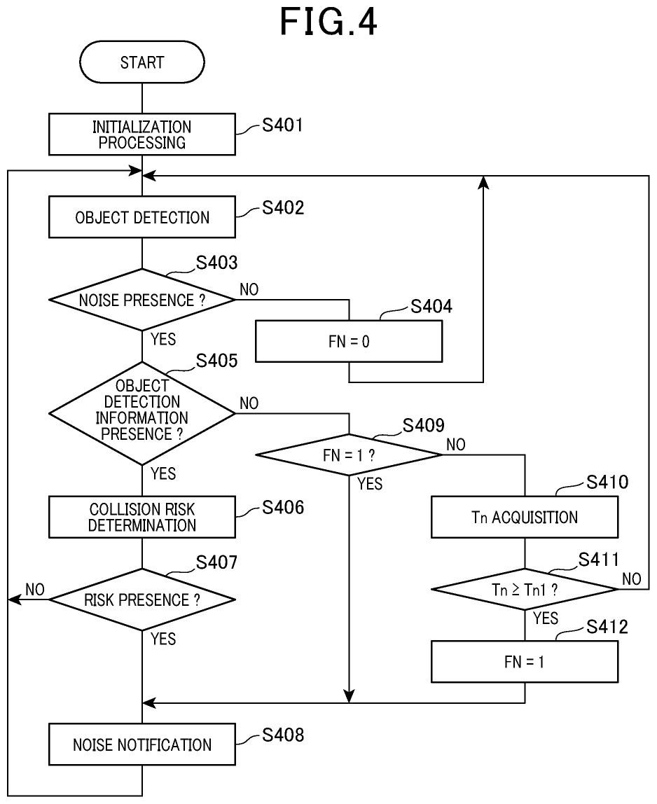

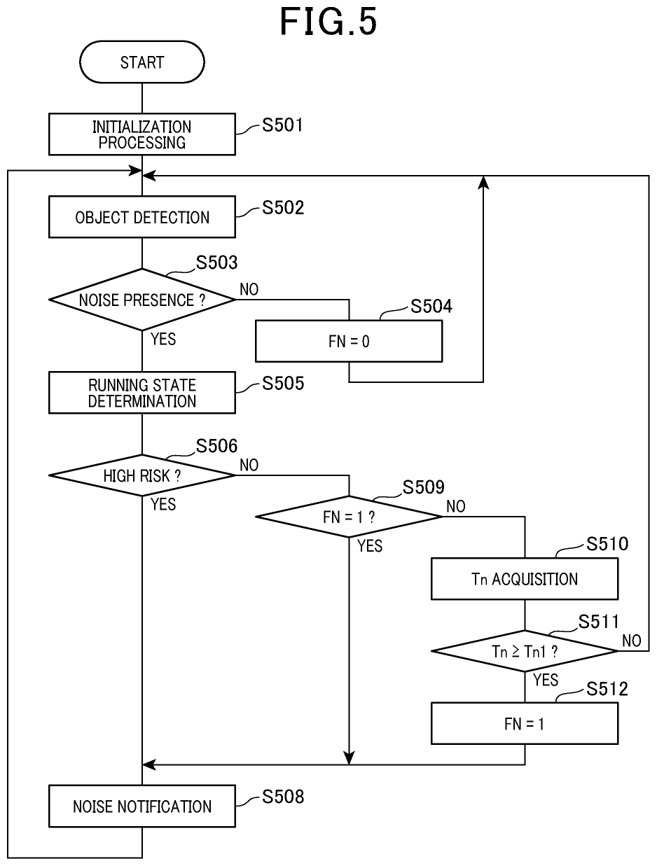

Hereinafter, another operation example will be described with reference to FIG. 4 in addition to FIG. 1 and FIG. 2. FIG. 4 is a flowchart corresponding to this operation example. In FIG. 4, “S” is an abbreviation for “step”. The same holds true for the flowchart of FIG. 5. Moreover, in the following descriptions, the processor 21a provided in the object detection ECU 21 is simply abbreviated as “CPU”.

First, at step S401, the CPU executes initialization processing for initializing various counters and flags. Next, at step S402, the CPU executes object detection processing using an object detection sensor such as the sonar sensor 22. This object detection processing includes acquisition of information or signals output from the object detection sensor such as the sonar sensor 22, determination of the presence or absence of object B based on these acquired information or signals, and calculation of the relative position. Subsequently, at step S403, the CPU determines whether exogenous noise has been received at the current processing timing.

When the exogenous noise has not been received (that is, step S403=NO), the CPU returns the process to step S402 after executing the process of step S404. At step S404, the CPU resets the noise continuation flag FN (that is, FN=0). Incidentally, when the noise continuation flag FN is already in the reset state immediately before executing the process of step S404, the CPU retains the reset state of the noise continuation flag FN in step S404. On the other hand, when the exogenous noise has not been received (that is, step S403=YES), the CPU advances the process to step S405.

At step S405, the CPU determines whether there is detection information of object B within a predetermined region around the own vehicle. That is, the CPU determines whether it is in the detection state or in the non-detection state at the present time. When it is in the detection state (that is, step S405=YES), the CPU advances the process to step S406 and step S407.

At step S406, the CPU determines the risk of a collision or contact with a detected object B. Specifically, for example, the CPU calculates an evaluation value (such as TTC) corresponding to the risk of a collision or contact. TTC stands for Time to Collision. Alternatively, for example, the CPU can calculate such an evaluation value by considering the relative position of the object B with respect to the own vehicle. At step S407, the CPU determines whether the risk determined at step S406 has reached a predetermined degree at which the possibility of a collision or contact with the detected object B is high.

When there is a risk of a collision or contact (that is, step S407=YES), the CPU returns the process to step S402 after executing the process of step S408. At step S408, the CPU controls the HMI device 26 to execute the noise related notification. When there is no risk of a collision or contact (that is, step S407=NO), the CPU skips the process of step S408 and returns the process to step S402.

When there is no detection information of object B within the predetermined region around the own vehicle (that is, step S405=NO), the CPU advances the process to step S409. At step S409, the CPU determines whether the noise continuation flag FN is set (that is, whether FN=1). The state in which the noise continuation flag FN is set corresponds to the state in which the noise continuation state in FIG. 3 is ON.

When the noise continuation flag FN is set (that is, step S409=YES), the CPU advances the process to step S408. On the other hand, when the noise continuation flag FN is reset (that is, step S409=NO), the CPU advances the process to step S410 and step S411.

At step S410, the CPU acquires a continuation state parameter Tn indicating a continuation state of the exogenous noise (that is, duration or the number of continuations). At step S411, the CPU determines whether the continuous state parameter Tn is greater than or equal to the threshold Tn1. The threshold Tn1 corresponds to the determination threshold time Tβ in the first operation example described above.

When Tn<Tn1 (that is, step S411=NO), the CPU returns the process to step S402. When Tn≥Tn1 (that is, step S411=YES), the CPU advances the process to step S408 after executing the process of step S412. At step S412, the CPU sets the noise continuation flag FN (that is, FN=1).

As such, in this operation example, the noise related notification is more readily executed in the case in which object B, which may be an obstacle that may collide with the own vehicle, is detected than in the case in which the object B is not detected. Moreover, in this operation example, the noise notification processing unit 215 changes the execution modes of the noise related notification depending on the reception state of the exogenous noise. Furthermore, in this operation example, the noise notification processing unit 215 changes the execution modes of the noise related notification depending on the possibility that the detected object B collides with the own vehicle. Therefore, according to this operation example, it is possible to favorably notify the user that the object detection function has been restricted due to the exogenous noise while suppressing deterioration in convenience.

### Operation Example 3

Hereinafter, still another operation example will be described with reference to FIG. 5 in addition to FIG. 1 and FIG. 2. FIG. 5 is a flowchart corresponding to this operation example. The processing contents of step S501 to step S504 in FIG. 5 are the same as the processing contents of step S401 to step S404 in FIG. 4, respectively. As such, descriptions of the processing contents of step S501 to step S504 are omitted.

At step S505, the CPU determines the running state of the own vehicle. Specifically, the CPU determines the running scene of the own vehicle based on the information or signals corresponding to various quantities relating to driving state of the own vehicle acquired from the vehicle state sensor 25. At step S506, the CPU determines whether the driving state determined at step S505 is a high-risk driving state. The “high-risk driving state” is a driving scene in which the risk of the own vehicle colliding with or contacting object B present in the surroundings of the own vehicle is assumed to be high, for example, reversing, low-speed driving, starting, turning left or right, lane changing, parking and the like.

When a vehicle is a high-risk driving state (that is, step S506=YES), the CPU advances the process to step S508. On the other hand, when a vehicle is in a low-risk driving state (that is, step S506=NO), the CPU advances the process to step S509. The processing contents of step S508 to step S512 in FIG. 5 are the same as the processing contents of step S408 to step S412 in FIG. 4, respectively. As such, descriptions of the processing contents of step S508 to step S512 are omitted.

As such, in this operation example, the ease with which the noise related notification is executed is determined depending on the running state of the own vehicle. Moreover, in this operation example, the noise notification processing unit 215 changes the execution modes of the noise related notification depending on the reception state of the exogenous noise. Furthermore, in this operation example, the noise notification processing unit 215 changes the execution modes of the noise related notification depending on the possibility that the detected object B collides with the own vehicle. Therefore, according to this operation example, it is possible to favorably notify the user that the object detection function has been restricted due to the exogenous noise while suppressing deterioration in convenience.

### Operation Example 4

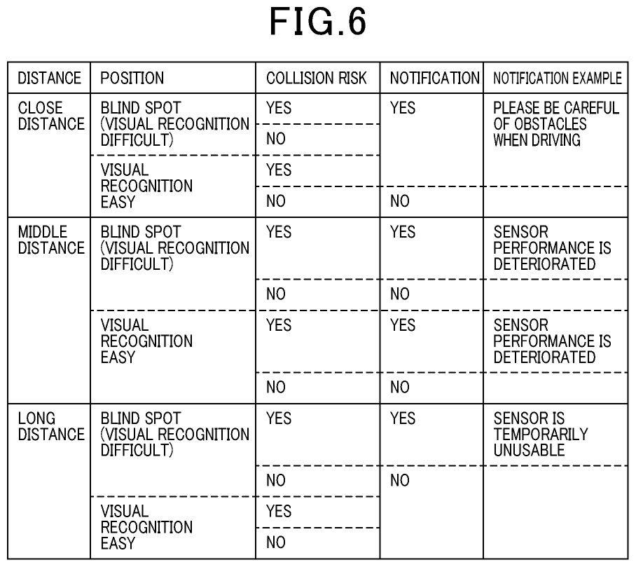

FIG. 6 shows relations among the distance to the detected object B from the own vehicle, the relative position of the object B to the own vehicle, and the risk of collision or contact of the own vehicle with the object B, and the execution modes of the noise related notification. Incidentally, the “collision risk” in FIG. 6, that is, the risk of collision or contact of the own vehicle with object B, is considered to be determined, for example, in consideration of the planned travel trajectory of the own vehicle and the position or planned movement trajectory of the object B. The table shown in FIG. 6 can also be overlappingly applied to each of the above operation examples.

As shown in FIG. 6, when object B exists in a short distance (for example, within 0.75 m), and in a blind spot area which makes it difficult for a driver to visually recognize it, regardless of the presence or absence of a collision risk, the noise notification processing unit 215 executes the noise related notification. On the other hand, when object B exists in a short distance, and in a non-blind spot area which make it easy for a driver to visually recognize it, the noise notification processing unit 215 executes the noise related notification depending on the presence or absence of a collision risk. A notification example in the case of a short distance is, for example, “Please be careful of obstacles when driving.”

In the case of a medium distance (for example, 0.75 to 2 m), regardless of the relative position of object B to the own vehicle, the noise notification processing unit 215 executes the noise related notification depending on the presence or absence of a collision risk. That is, when there is a risk of a collision or contact of the own vehicle with object B, regardless of whether the relative position of the object B is in a blind spot area, the noise notification processing unit 215 executes the noise related notification. A notification example in the case of a medium distance is, for example, “Sensor performance is deteriorated.”

In the case of a long distance (for example, 2 m or more), the noise notification processing unit 215 executes the noise related notification under the conditions that there is a risk of a collision or contact of the own vehicle with object B, and that the object B exists in a blind spot area which makes it difficult for a driver to visually recognize it. On the other hand, under other conditions, the noise notification processing unit 215 does not execute the noise related notification.

As such, in this operation example, the noise notification processing unit 215 changes the execution modes of the noise related notification depending on the possibility that the detected object B collides with the own vehicle. Therefore, according to this operation example, it is possible to favorably notify the user that the object detection function has been restricted due to the exogenous noise while suppressing deterioration in convenience.

### Modification Examples

This disclosure is not limited to the above embodiments. Therefore, the above embodiment can be modified as appropriate. Hereinafter, representative modification examples will be described. In the following description of the modification examples, differences from the above embodiments will be mainly described. Moreover, in the above embodiments and modification examples, the same or equivalent portions to each other are denoted by the same reference numerals. Therefore, in the descriptions of the modification examples below, regarding the constituents having the same reference numerals as the above embodiments, descriptions in the above embodiments may be used as appropriate unless there is a technical contradiction or special additional description.

This disclosure is not limited to the specific device configurations shown in the above embodiments. That is, for example, the vehicle 10 loaded with the in-vehicle system 20 is not limited to a four-wheeled vehicle. Specifically, the vehicle 10 may be a three-wheeled vehicle, or a six-wheeled or eight-wheeled vehicle such as a cargo truck. The type of vehicle 10 may be an automobile provided only with an internal combustion engine, an electric vehicle or a fuel cell vehicle without an internal combustion engine, or a so-called hybrid vehicle. The shape and structure of the vehicle body 11 are also not limited to a box shape, that is, a substantially rectangular shape in a plan view. The number of door panels 17 is also not particularly limited.

There are also no particular limitations on the application targets of the in-vehicle system 20. For example, the in-vehicle system 20 is not limited to a driving support system, that is, an automatic driving system for realizing semi-automatic driving or automatic driving corresponding to level 2 to level 5 in the definition of automatic driving. Specifically, for example, the in-vehicle system 20 may be an obstacle notification system that notifies the presence or absence of an obstacle, a parking support system that supports parking the own vehicle in a parking space, or an automatic parking system.

In the above embodiments, the object detection ECU 21 has a configuration such that the CPU reads out a program from a ROM or the like and starts it up. However, this disclosure is not limited to such configurations. That is, for example, the object detection ECU 21 may have a digital circuit configured to enable the above operations, for example, a configuration provided with ASIC or FPGA. ASIC stands for Application Specific Integrated Circuit. FPGA stands for Field Programmable Gate Array.

The arrangement and the number of sonar sensors 22 are not limited to the above specific examples. That is, for example, referring to FIG. 1, when the third front sonar SF3 is arranged at the center position in the vehicle width direction, the fourth front sonar SF4 is omitted. Similarly, when the third rear sonar SR3 is arranged at the central position in the vehicle width direction, the fourth rear sonar SR4 is omitted. For example, when the in-vehicle system 20 does not have a parking support or automatic parking functions. the third side sonar SS3 and the fourth side sonar SS4 may be omitted.

The arrangement and the number of cameras 23 are not limited to the above example. That is, for example, the front camera CF may be arranged inside or outside the vehicle. Specifically, for example, the front camera CF may be mounted to a room mirror (not shown in the figure) arranged inside the vehicle of the vehicle 10. Alternatively, for example, the front camera CF may be mounted to the front part 12 of the vehicle body 11. The left side camera CL and the right side camera CR may be arranged at a position different from the position of the door mirror 18. Alternatively, the left side camera CL and right side camera CR may be omitted.

As the radar sensor 24, both a laser radar sensor and a millimeter wave radar sensor may be loaded on the own vehicle. The millimeter wave radar sensor as the radar sensor 24 may be a so-called sub-millimeter wave radar sensor.

In the above embodiments, the in-vehicle system 20 is provided with the sonar sensor 22, the camera 23, and the radar sensor 24 as an object detecting sensor. However, this disclosure is not limited to such aspect. That is, for example, the in-vehicle system 20 may be provided only with the sonar sensor 22 as an object detecting sensor. Alternatively, for example, the in-vehicle system 20 may be provided only with the radar sensor 24 as an object detecting sensor. This disclosure may be suitably applied to these cases as well.

This disclosure is not limited to the specific functional configurations or operational modes shown in the above embodiments. That is, for example, in the above embodiments, both the object detecting sensor for monitoring the reception state of the exogenous noise and the object detecting sensor for distinguishing between the detection state and the non-detection state were sonar sensors 22. However, this disclosure is not limited to such aspect. Therefore, for example, depending on whether the object B was detected by the camera 23 or the radar sensor 24, a difference may be provided in the determination of the high noise state and the noise related notification in the sonar sensor 22.

The functional configuration of the object detection ECU 21 is also not limited to the specific examples shown in the above embodiments. That is, for example, all or part of the functions of the noise state determination unit 214 may be provided in the noise notification processing unit 215. Alternatively, all or part of the functions of the noise notification processing unit 215 may be provided in the noise state determination unit 214.

The frequency of the noise related notification may be set by a user. Specifically, for example, an operation for the user to adjust the frequency of the noise related notification may be executed by an input device provided on the HMI device 26. Corresponding to such operation, parameters relating to the frequency of the noise related notification may be changed. Such parameters are, for example, the waiting time in “Tα<predetermined waiting time”, the determination threshold time Tβ, the threshold Tn1 in FIG. 4 and FIG. 5 and the like. This improves convenience of the user.

An adjustment of the ease of executing of the noise related notification may be an adjustment of the execution frequency of the noise related notification as in the above embodiments, it may be an adjustment of the determination threshold for determining whether the high noise state is established, or it may be both. That is, for example, a lower determination threshold may be used in the detection state of object B than in the non-detection state thereof. Alternatively, for example, a lower determination threshold may be used in the high-risk running state than in the low-risk running state.

The expression “acquisition” and similar expressions such as “estimation”, “detection”, “detection”, “calculation” and the like can be appropriately replaced with each other within a technically consistent range. Both “detection” and “extraction” can be appropriately replaced with each other within technically consistent range. The inequality sign in each determination process may or may not include an equality sign. That is, for example, “less than the threshold” and “less than or equal to the threshold” may be replaced with each other within the scope of technical contradiction.

Needless to say, the elements constituting the above embodiments are not necessarily essential, unless explicitly stated as essential or clearly considered essential in principle. Moreover, when numerical values such as the number, amount, range, etc. of a constituent element are referred to, unless it is explicitly stated that it is particularly essential or it is clearly limited to a specific numerical value in principle, this disclosure is not limited to the specific numerical value. Similarly, when the shape, direction, positional relationship, etc. of the constituent element, etc. are referred to, unless it is explicitly stated that it is particularly essential or it is limited to a specific shape, direction, positional relationship, etc. in principle, this disclosure is not limited to the shape, direction, positional relationship.

Modification examples are also not limited to the above examples. For example, a plurality of operation examples may be combined with one another unless they are technically inconsistent. Moreover, a plurality of modification examples can be combined with one another unless they are technically inconsistent. Furthermore, all or part of the above embodiments and all or part of the modification examples may be combined with one another unless they are technically inconsistent.

What is claimed is:

1. An object detection device configured to detect an object present in the surroundings of an own vehicle, comprising:
an object detection determination unit that determines, while the object detection condition is valid, whether the object is in a detection state where the object is detected, or the object is in a non-detection state where the object is not detected;
a noise state determination unit that determines, while the object detection condition is valid, whether the reception state of exogenous noise in the object detecting sensor is a high noise state; and
a noise notification processing unit that, when the noise state determination unit determines that the reception state of the exogenous noise is the high noise state, executes a noise related notification corresponding to a generation of a restriction in the object detection function as a result of the high noise state; wherein
the object detection device is configured such that the noise related notification is more readily executed in the detection state than in the non-detection state.

2. The object detection device configured to detect an object present in the surroundings of an own vehicle, comprising:
a noise state determination unit that determines, while the object detection condition is valid, whether the reception state of exogenous noise in the object detecting sensor is a high noise state; and
a noise notification processing unit that, when the noise state determination unit determines that the reception state of the exogenous noise is the high noise state, executes the noise related notification corresponding to a generation of a restriction in the object detection function as a result of the high noise state; wherein
the object detection device is configured such that the ease of executing the noise related notification is determined depending on the running state of the own vehicle.

3. The object detection device according to claim 1, wherein
the noise notification processing unit changes execution modes of the noise related notification depending on the probability of a collision of the detected object with the own vehicle.

4. The object detection device according to claim 1, wherein
the noise notification processing unit changes execution modes of the noise related notification depending on the reception state of the exogenous noise.

5. The object detection device according to claim 1, wherein
the noise notification processing unit executes the noise related notification using an HMI device provided with a display device, sound output device, and/or haptic device.

6. The object detection device according to claim 1, wherein
the object detecting sensor is a sonar sensor, camera, and/or radar sensor.

7. The object detection device according to claim 1, wherein
the frequency of the noise-related notification can be set by the user.

8. The object detection device according to claim 2, wherein
the noise notification processing unit changes execution modes of the noise related notification depending on the probability of a collision of the detected object with the own vehicle.

9. The object detection device according to claim 2, wherein
the noise notification processing unit changes execution modes of the noise related notification depending on the reception state of the exogenous noise.

10. The object detection device according to claim 2, wherein
the noise notification processing unit executes the noise related notification using an HMI device provided with a display device, sound output device, and/or haptic device.

11. The object detection device according to claim 2, wherein
the object detecting sensor is a sonar sensor, camera, and/or radar sensor.

12. The object detection device according to claim 2, wherein
the frequency of the noise-related notification can be set by the user.

13. An object detection method that detects an object present in the surroundings of an own vehicle, comprising:
determining, while the object detection condition is valid, whether the object is in a detection state where the object is detected, or the object is in a non-detection state where the object is not detected;
determining, while the object detection condition is valid, whether the reception state of the exogenous noise in the object detection sensor is a high noise state; and
when it is determined that the reception state of the exogenous noise in the object detection sensor is the high noise state, executing the noise related notification corresponding to a generation of a restriction in the object detection function as a result of the high noise state; wherein
the noise related notification is more readily executed in the detection state than in the non-detection state.

14. An object detection method that detects an object present in the surroundings of an own vehicle, comprising:
determining, while the object detection condition is valid, whether the reception state of the exogenous noise in the object detection sensor is a high noise state;
when it is determined that the reception state of the exogenous noise in the object detection sensor is the high noise state, executing the noise related notification corresponding to a generation of a restriction in the object detection function as a result of the high noise state; and
determining the ease of executing the noise related notification depending on the running state of the own vehicle.

15. An object detection program executed by an object detection device configured to detect an object present in the surroundings of an own vehicle, wherein
the process executed by the object detection device comprises:
a process of determining, while the object detection condition is valid, whether the object is in a detection state where the object is detected, or the object is in a non-detection state where the object is not detected;
a process of determining, while the object detection condition is valid, whether the reception state of the exogenous noise in the object detection sensor is a high noise state; and
when it is determined that the reception state of the exogenous noise in the object detection sensor is the high noise state, a process of executing the noise related notification corresponding to a generation of a restriction in the object detection function as a result of the high noise state; wherein
the noise related notification is more readily executed in the detection state than in the non-detection state.

16. An object detection program executed by an object detection device configured to detect an object present in the surroundings of an own vehicle, wherein
the process executed by the object detection device comprises:
a process of determining, while the object detection condition is valid, whether the reception state of the exogenous noise in the object detecting sensor is a high noise state;
when it is determined that the reception state of the exogenous noise in the object detecting sensor is the high noise state, a process of executing the noise related notification corresponding to a generation of a restriction in the object detection function as a result of the high noise state; and
a process of determining the ease of executing the noise related notification depending on the running state of the own vehicle.
